(19) United States
(12) Patent Application Publication
(10) Pub. No.: US 2008/0038405 A1
(43) Pub. Date: Feb. 14, 2008

(54) Method for Producing Sour Milk Products, Method for Treating Milk Therefor, Sour Milk Production Line, Device For Treating Milk for Said Line

(76) Inventors: Viktor Vasilievich Marchenko, Vladivostok (RU); Alexandr Mikhailovich Lutcenko, Moskva (RU); Valery Alexandrovich Sotnikov, Kazan (RU)

Correspondence Address: Ilya Zborovsky, 6 Schoolhouse Way, Dix Hills, NY, 11746, US

(21) Appl. No.: 11/659,783

(22) PCT Filed: Aug. 8, 2005
(86) PCT No.: PCT/RU05/00405

§ 371 Date: Feb. 8, 2007

(30) Foreign Application Priority Data
Aug. 17, 2004 (RU) 2004125189

(51) Int. Cl. A23C 9/12; A23C 3/07; A23C 9/00

(52) U.S. Cl. 426/34; 426/580; 99/451

(57) ABSTRACT

The present inventions belong to the milk industry and can be used for producing pasteurized whole or restored milk and sour milk products on their basis, with a long-term storage time and improved organoleptic characteristics. The inventions provide more careful sterilization of milk and elimination of secondary contamination of products during all production stages thereof. The inventions consist in the method for producing sour milk products consisting in carrying out a milk treatment process and subsequent operations in the presence of soluble in milk derivative of polyphosphoric acid of general formula
HO—[PO₃X]ₙ—PO₃X₂, wherein X represents sodium, or potassium, or calcium, or magnesium, or hydrogen or ammonium ions, and 30≧n≧1 at a quantitative value thereof ranging from 0.4 to 0.7 g/l; the milk treatment is carried out with double pasteurization, bottling and packing are associated with hermetic sealing at a temperature of 68-72° C. up to the second pasteurization, ferment is applied into hermetically sealed milk at ultraviolet irradiation of applying ferment area and is followed by the final hermetic sealing of a package afterwards. The invention also consists in the method of milk treating when after the first pasteurization the milk is kept at a temperature 68-72° C. for not less than 15 minutes for a drinking milk, and not less than 5 minutes for sour milk products, bottling with hermetic sealing is carried out after this keeping at the said temperature, then hermetically sealed milk is cooled down to a temperature of 12-37° C. and kept at this temperature for not less than 30 minutes, the second pasteurization is carried out after the said keeping by heating the milk to a temperature 68-72° C. at a heating rate equal to or greater than 10° C./sec. The inventions also consist in the structural design of the line for realization of the method of production of sour milk products, in the structural design of the device for milk treating for realization of the method of milk treating.

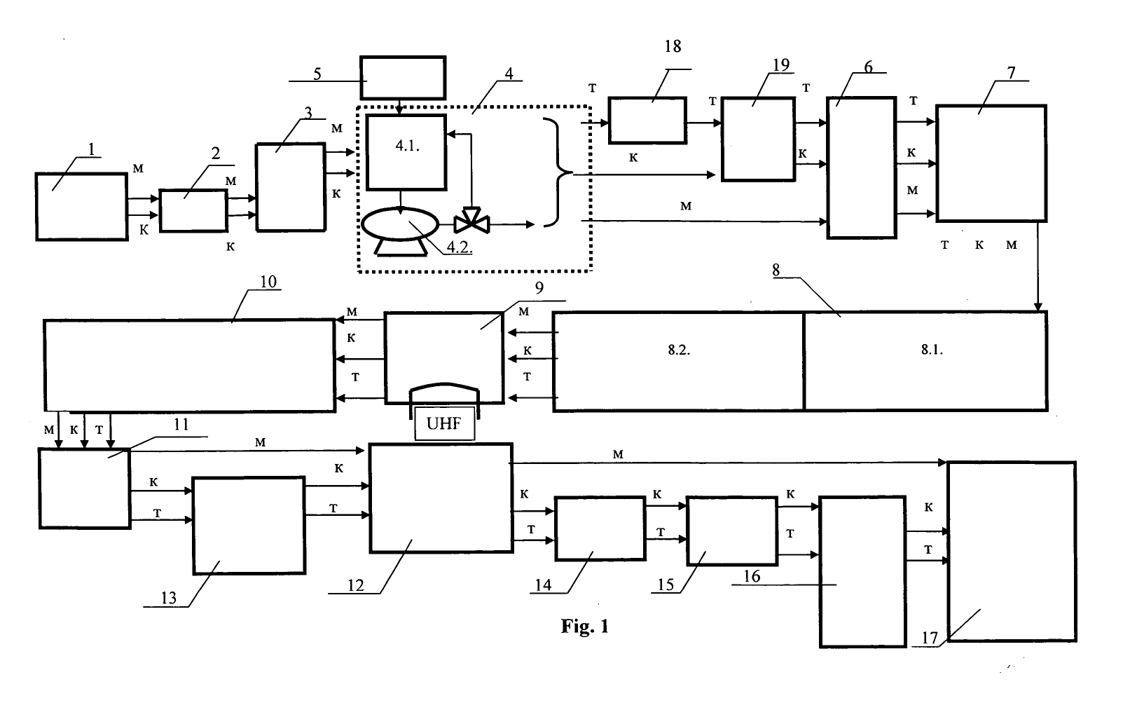

### THE FIELD OF ENGINEERING THE INVENTIONS BELONG TO

The present inventions relate to the milk industry and can be used for producing pasteurized whole or restored milk and sour milk products on their basis with long-term storage time preservation and improved organoleptic characteristics.

### THE PRECEDING LEVEL OF ENGINEERING

There is a technological process of reservoir producing sour milk products, when the treating milk is fermented in special vessels in which it ripens and is bottled afterwards (see “Technology and technics of processing milk. By Bredichin A. S., Kosmodemyansky Y. V., Yurin V. N. Moscow, Kolos, 2001, 399 pages, p. 272 [1]). The disadvantage of the reservoir method of producing sour milk products is a high degree of contamination of the produce with microflora as a result of its incomplete elimination during the pasteurization, germination of the spores left after the pasteurization, contamination the produce with microflora during applying ferment, fermentation, cooling, ripening, non-aseptic or semi-aseptic packing into non-aseptic or semi-aseptic package. Sour milk products, e.g. kefir, when produced by the reservoir method, as a result of growing foreign microflora in the final product and insufficient solubility of milk protein, have worse organoleptic properties, viz. a low degree of viscosity, non-characteristic structure and consistence, their expiry terms do not exceed 24 hours.

There is a thermostatic technology of producing sour milk products, e.g. kefir, which consists of the following operations: preparing raw milk, treating milk with pasteurization and homogenization, fermentation milk by direct applying ferment with stirring, bottling and packing, fermentation, cooling, ripening (see “Technology and technics of processing milk. By Bredichin A. S., Kosmodemyansky Y. V., Yurin V. N. Moscow, Kolos, 2001, 399 pages, p. 275 [1]). The processed milk, pasteurized and cooled, is fermented in reservoirs and vessels, stirred and is delivered in portions for bottling with permanent stirring. The fermented milk in package is delivered to the thermostatic chamber for fermentation during 8-12 hours at 17-25° C. depending on the season. After fermentation the kefir has a dense clot with acidity 75-80° T. The fermented kefir is delivered to the cooling chamber for cooling down to 8° C. and ripening at this temperature during not less than 12 hours. The described process of producing sour milk products is the closest analogue of the method of producing sour milk products, from which the described above disadvantages of the reservoir method are partly eliminated. However, the products obtained by the thermostatic method still have the short preservation term of 24 hours at 8° C., which is explained by a high quantity of spore-breeding organisms in both vegetative and spore forms as a result of insufficient disinfection of milk on which basis sour milk products are produced and secondary contamination of milk, inevitable at reserving pasteurized milk in reservoir machinery, at its transporting by technologic communications, at packing final product both under non-aseptic and semi-aseptic conditions. Besides, on account of inevitable breach of calcium and phosphor balance of raw milk as a result of its pasteurization and reducing solubility of denaturized milk protein, especially in restored milk, sour milk products, kefir in particular, have poor organoleptic characteristics.

There exists a method of producing pasteurized milk, including its normalization, homogenization, pasteurization, cooling and packing, which is used for producing drinking milk and sour milk products, when milk is pasteurized twice and cooled down to 2-6° C. between the two stages of pasteurization (see patent of Russia Ng 2166855, Method of producing pasteurized milk (variants), IPC7 A23C9/00 published May. 20, 2001. [2]). For further increasing of expiry terms the milk is bactofugated after normalization and pre-heating. The disadvantages of this method are short expiry terms of milk which do not exceed 5 days, low organoleptic properties of this pasteurized milk which has a taste of pasteurization due the secondary pasteurization at high temperatures of 70-85° C. The same disadvantages are found in sour milk product made from this milk.

The closest analogue of the method for treating milk is the method in accordance with patent of Russia No. 2222952, Method of producing drinking milk and the processing line for it, IPC7 A23C9/00,3/00, A01J11/00 published Feb. 10, 2004. bulletin No. 4 [3]. The method of treating consists in purification of milk from mechanic admixtures, its short heating with a source of infra-red radiation, bactofugation for elimination of inactivated microflora from milk, combined process of dispersion (homogenization) and pasteurization with the use of a multi-stage rotary pulsation apparatus where additional acoustic vibrations are produced for heating milk. Dispersion (homogenization) is carried out in the mode of frequentative circulation of a single portion of milk at 68-72° C. with unregulated quality of homogenization of butter-fat globules in the wide diapason of their sizes from 0.5 to 1.1 mcm with the possibility of its repetition at increased acidity of milk, i.e. at a high degree of its contamination. Packing milk is carried out after its cooling down to 4-6° C.

The disadvantage of this method is producing milk and products on its basis with a preservation term which is not long and stable enough, the cause of it being insufficient sterilization of microflora of milk, secondary contaminating milk with microflora in pipelines and tanks after dispersion and pasteurization before packing; low thermostability of milk.

There exists a sour milk production line with the use of the thermostatic method that carries out the closest known way of producing sour milk products (see “Technology and technics of processing milk. By Bredichin A. S., Kosmodemyansky Y. V., Yurin V. N. Moscow, Kolos, 2001, 399 pages, p. 272, 273 [1]). The line contains a device for treating milk with a pasteurization plant, a homogenizer and a setting reservoir, a device for applying ferment, a packing machine, a thermostatic chamber, a cooling chamber installed in the order of technological operations. This line is the closest analogue of the line in accordance with the invention. The disadvantage of the known line is the short preservation term of the sour milk products produced by this line, which is 24 hours at 8° C., which is explained by a high quantity of spore-breeding organisms in both vegetative and spore forms as a result of insufficient disinfection of milk on which basis sour milk products are produced and secondary contamination of milk and sour milk products, inevitable at reserving them in reservoir machinery, at its transporting by technologic communications, at packing final product both under non-aseptic and semi-aseptic conditions.

The closest analogue of the device for treating milk is the line for producing milk in accordance with patent of Russia No. 2222952, Method of producing drinking milk and the processing line for it, IPC7 A23C9/00,3/00, A01J11/00, published Feb. 10, 2004., bulletin No. 4 [3]. The line contains a raw milk collector, a heat exchanger provided with a source of infra-red radiation, a bactofugeur, a multi-stage rotary pulsation apparatus with an intermediate reservoir for dispersion and pasteurization, a cooler and a packing machine installed in the order of technological operations and connected by a system of pipelines. The output of the rotary pulsation apparatus is connected to the input of the intermediate reservoir whose output is connected to the input of the rotary pulsation apparatus (RPA) thus making a closed circuit of frequentative circulation of milk through the RPA. The RPA is provided with a thermocontrol of milk heating electrically connected with an executive device which is a drive of a switchboard of a three-passage cock for temperature control of treating milk in the RPA.

The disadvantage of the device is producing milk with a preservation term which is not long and stable enough, low thermostability of milk, low organoleptic characteristics and as a result low quality of the products made from this milk.

### Formulating the Problem Solved by the Inventions

The aim of the inventions is producing sour milk products, treating milk for them with long preservation term, high thermostability, improved organoleptic characteristics by way of more thorough sterilization of milk and exception of secondary contamination of products in the process of their producing at all stages.

### DESCRIPTION OF THE INVENTIONS

The problem is solved by the method for producing sour milk products including preparing raw milk, treating milk with pasteurization and homogenizing, fermentation milk by the way of direct applying ferment with stirring if necessary, bottling and packing with hermetic sealing, fermentation in thermostat, cooling, ripening. The distinction from the prototype is that process of treating milk and the following operations of producing sour milk products are carried out in presence of a derivative of polyphosphoric acid (further DPPA), which is soluble in milk (milk plasma) and has a general formula
HO—[PO₃X]ₙ—PO₃X₂,
wherein X represents ions of sodium, or potassium, or calcium, or magnesium, or hydrogen, or ammonium, 30≧n≧1, its value being 0.4-0.7 g/l, treating milk is carried out with double pasteurization, bottling and packing with hermetic sealing are carried out at 68-72° C. before the second pasteurization, ferment is applied into hermetically sealed milk after the second pasteurization at depressurization of package and with ultra-violet radiation of the area of applying ferment with final hermetic sealing of package afterwards, stirring with necessity is carried out by the way of shaking packed product. This method of producing sour milk products can be supplemented with the operation of stewing (baking) milk or applying pasteurized pieces of vegetables, or fruit, or berries, or other fillings (vegetable or milk proteins, sugar, flavourings, fruit and berry juices, jam, marmalade, etc.) to the milk after its first pasteurization, for milk and sour milk products at 68-72° C., for stewed milk and its derivatives at stewing temperature.

The problem is also solved by the method of treating milk which includes purification milk from mechanical admixtures, its preliminary heating, combining process of dispersion (homogenizing) and pasteurization with secondary pasteurization. Dispersion (homogenization) is carried out in the mode of frequentative circulation of a single portion of milk at pasteurization temperature with hermetic bottling afterwards. The distinction of this method of treating milk is that treating milk is carried out in presence of a derivative of polyphosphoric acid (DPPA), which is soluble in milk (in plasma of milk) and has a general formula
HO—[PO₃X]ₙ—PO₃X₂,
wherein X represents ions of sodium, or potassium, or calcium, or magnesium, or hydrogen, or ammonium, 30≧n≧1, its value being 0.4-0.7 g/l, the process of dispersion (homogenizing) is not kept on after the size of the butter-fat globules is 0.5 mcm, after the first pasteurization the milk is kept at 68-72° C. for not less than 15 minutes for drinking pasteurized milk, not less than 5 minutes for sour milk products, which is followed by bottling and hermetic sealing at the above mentioned temperature, cooling the hermetically sealed hot milk down to 12-37° C., after which the milk is kept at this temperature for not less than 30 minutes, then the secondary pasteurization is carried out with heating milk by ultra-high-frequency (UHF)-radiators up to 68-72° C. as fast as 10° C./sec.

The problem is also solved by the construction of the sour milk production line, which contains consequently connected by a transporter in the order of technological operations device for treating milk with a homogenizer, pasteurization plant, a device for direct applying ferment, and also a packing apparatus (bottling device) provided with hermetic sealing device; a thermostatic chamber, a cooling chamber. The distinction of the sour milk production line from the prototype is the position of the bottling device before the device for direct applying ferment; the construction of the transporter after the bottling device being not that of a pipeline, but of a belt conveyor or a transporting hydrodynamic tunnel; the device for direct applying ferment is complementary provided with a depressurizing device, which can be designed as a device for removing hermetic film from milk package, with a device for final hermetic sealing, which can be installed after the device for direct applying ferment, with ultra-violet radiators installed along the perimeter (border) of ferment applying area and final hermetic sealing area, designing the device for stirring bottled and assembled into blocks milk with ferment as a shaking belt conveyor installed between the ferment applying device and the thermostatic chamber.

The problem is also solved by the device for treating milk including installed in the order of technological operations and connected by the system of pipelines raw milk collector, pump, heat exchanger, recirculation dispersion (homogenization) and pasteurization reservoir, disperser (homogenizer), as well as cooler (cooling chamber) and bottling device. The output of the disperser (homogenizer) is connected with the input of the recirculation reservoir through a three-passage cock; the output of the recirculation reservoir is connected with the input of the disperser (homogenizer) providing closed circuit of frequentative circulation of milk through the disperser (homogenizer). The disperser (homogenizer) is equipped with a thermoregulator of milk heating electrically connected with an executive device which is a drive of a switchboard of a three-passage cock. The distinction of the offered construction from the prototype is an additional reservoir for preparing water solution or suspension of a derivative of polyphosphoric acid (further DPPA reservoir) taken from the given above range; the DPPA reservoir is connected with the input of the disperser (homogenizer); it is also a setting reservoir for keeping milk at 68-72° C. which is provided with a water jacket that keeps milk at 68-72° C., its input is connected with the output of the disperser (homogenizer) and output is connected with the bottling device installed at the setting reservoir. The setting reservoir can be designed as a mixing or displacing apparatus with a jacket that supports the temperature at 68-72° C. Supporting temperature is carried out by connecting the water jacket to the current of heat carrier (thermal liquid) (e.g. water, steam, milk). The milk treating device is also equipped with a cooler installed after the bottling device; the first can be designed as a transporting hydrodynamic passage tunnel of cooling provided with a second setting reservoir for keeping milk at 12-37° C. In addition the milk treating device is equipped with a tunnel apparatus of secondary pasteurization with a transporting belt which is provided with UHF-radiators installed along the transporting belt. The UHF-radiators provide the rate of heating milk which is not less than 10° C./sec up to 68-72° C. that depends on the power of the UHF-radiators.

### FIGURE, TABLE

The FIGURE shows the block scheme of the sour milk production line including the device for treating milk with long preservation term and good organoleptic characteristics; the table shows the results of treating milk, producing sour milk products and the characteristics of the drinking pasteurized milk, sour milk products under different conditions of their produce.

### THE DESCRIPTION OF THE LINE AND THE DEVICE IN STATICS

The line consists of consequently connected raw milk collector—collector reservoir 1, pump 2, heat exchanger—milk thermizator 3, the system of dispersion (homogenizing) and pasteurization consisting of recirculation reservoir of dispersion and pasteurization 4.1., pump—disperser or rotary pulsation apparatus 4.2. (further RPA), with the system of pipelines and valve lock reinforcement (shown in lines schematically). The output of the recirculation reservoir 4.1. is connected with the input of the RPA 4.2., whose output is connected with the input of the recirculation reservoir 4.1. through valve lock reinforcement. The pump-disperser 4.2. can be designed as a homogenizer, colloidal mill, injection mixer, sprayer, pump-disperser (see New Polytechnical Dictionary, Scientific publishing house “Comprehensive Russian Encyclopedia”, 2000, p. 118, 145), rotary pulsation apparatus (see patent RU No. 2166986 in force from May 11, 1999) and the like equipment. The following appliances can serve as a disperser: rotary pulsation apparatus (S-emulsifier), model TT 520.00, manufactured by closed joint-stock company “Industrial Technologies”, Russia; pump-disperser model RPA-25-5(55,55A)-K, manufactured by ENA company, Russia; plunger homogenizer, model Al-OGM-2,5, Russia). If needed the homogenizer can be equipped with a supplementary heater for providing required temperature mode. Recirculation mode is provided by a feedback circuit through supplying a portion of milk from the output of the disperser to its input via the recirculation reservoir. The system 4 of dispersion and pasteurization is equipped with reservoir 5 for preparing solution of the derivative of polyphosphoric acid (further DPPA reservoir) which can be designed as a reservoir with a stirrer or without it. The line contains setting reservoir 6 which can be designed as a chamber looking like a pipe through which milk flows in a persistent stream under isothermal conditions. The chamber can be designed as a pipe, a cylinder reservoir with a jacket, a pipe coil, etc. The line contains bottling device 7 with preliminary hermetic packing, unit apparatus of hydrodynamic tunnel 8 consisting of convective cooling section 8.1. where milk is cooled down to 12-37° C. and setting section 8.2. where milk is kept at 12-37° C.; tunnel apparatus of secondary pasteurization 9, hydrodynamic cooling tunnel 10 or other cooling device, e.g. sprayer (see [1] p. 70), drying apparatus 11, apparatus of packing and labeling 12, apparatus of direct applying ferment 13, block-packing apparatus 14, shaking belt conveyor 15, thermostatic chamber 16, cooling chamber 17. The line can be complemented with mix reservoir 18 installed between the output of dispersion and pasteurization system 4 and the input of setting reservoir 6. The line is also complemented with cooling heat exchanger 19 for sour milk products, stewed milk, additions which is installed between the system of dispersion and pasteurization 4 and the input of setting reservoir 6. The bottling device 7 can be designed as a bottling machine described in [1], p. 190-195, which uses plastic bottles for packing. Tunnel apparatus of secondary pasteurization 9 is designed as an isolated channel with a transporter belt moving inside along it; the bottles with milk are placed on the belt. There are UHF radiators (UHF) installed along the transporter belt. The design of the apparatus of direct applying ferment depends on the form of ferment and can carry out syringing, applying tableted ferment and other forms of ferment. The arrows schematically show transporting devices for applying raw stuff for drinking milk marked with M, for a sour milk product—K, for a sour milk product on the basis of stewed milk or raw milk with fillings—T.

### Realization of the Methods and Work of the Line and Device

The methods are realized and the devices work as following.

Mechanically purified, normalized on the degree of content of fat and cooled down to 4-6° C. whole or restored milk is delivered by pump 2 from collector reservoir 1 to milk thermizator 3 where milk is primarily heated to 55-65° C. for producing pasteurized milk and to 70-80° C. for producing sour milk products. The thermized milk is delivered to recirculation reservoir 4.1. of system of dispersion and pasteurization 4, where the milk is homogenized and pasteurized at the same time. The aim of pasteurization is sterilization of a wide variety of microorganisms in milk by its possibly minimum low temperature heating. At the same time solution or suspense of polyphosphoric acid derivative taken from the above mentioned range, in quantity 0.4-0.7 g/l is delivered from reservoir 5 of polyphosphoric acid derivative to recirculation reservoir 4.1. The quantity of polyphosphoric acid derivative depends on the degree of contamination, acidity of raw milk and acceptable taste properties of finished pasteurized milk and sour milk products on its basis. The work of system of dispersion and pasteurization 4 suggests periodic treating of a single portion of milk in the mode of dispersion and pasteurization to 68-72° C. for drinking milk, to 80-85° C. for a sour milk product. The number of cycles depends on this temperature which should not be exceeded, and on the degree of homogeneity of butter-fat globules the average size of which should not be more than 0.5 mcm. The degree of homogeneity of milk is determined in the current mode visually with the use of expressive microscopic methods. At this stage of treating milk the polyphosphoric acid derivative raises the effect of mechanical dispersion of microbe associates, disaggregation of microsubstrate associates, so raises their thermosensitivity for contributing to inactivation of spores and vegetative cells in milk and so the rate of their perishing at low-temperature pasteurization, hence raising the effectiveness of low-temperature pasteurization and increasing the expiry terms of milk and sour milk products made on its basis. Besides DPPA contributes to casein solution and prevents the breach of calcium-phosphoric balance in the process of milk pasteurization eventually increasing thermostability, organoleptic properties of drinking milk and products made on its basis.

After completion the periodic process of dispersion and pasteurization of a single portion of milk the latter is delivered with the help of disperser (homogenizer) 4.1. directly into the setting reservoir 6 where the milk is kept at 68-72° C. not less than 25 minutes for drinking pasteurized milk and not less than 15 minutes for sour milk products. Before keeping at this temperature the milk, further used for making sour milk products, requires cooling from the temperature of pasteurization 80-85° C. down to 68-72° C. The operation of keeping milk at 68-72° C. makes up for inefficiency of the above mentioned temperature for sterilizing the microorganisms which increases the effectiveness of pasteurization. The different time of keeping for different products is accounted for by the different pasteurization temperature for them. At this stage the milk can be supplied with a filling contained in mix reservoir 18 at the temperature of the first pasteurization for producing drinking milk. After keeping in reservoir 6 the milk is delivered to bottling device 7 at 68-72° C. for bottling with hermetic packing. The aim of hot bottling in producing drinking milk and sour milk products is decreasing secondary contamination of milk with microflora and simultaneous sterilizing microorganisms on the inner surface of the pipeline leading to the device of bottling and packing. Besides, bottling milk at 68-72° C. prolongs the process of keeping milk at this temperature decreasing the time of keeping milk in setting reservoir 6 down to 15 minutes for milk, to 5 minutes for sour milk products which makes the technological process faster. Bottled in hermetic package milk is further delivered to unit apparatus of hydrodynamic tunnel 8 where it is cooled down in convective cooling section 8.1 to 12-37° C. and kept in hermetic package at this temperature for not less than 30 minutes. These operations are necessary for converting most of the spore-breeding microorganisms of raw milk which failed to get sterilized at pasteurization and keeping at temperature of pasteurization and spore-breeding microorganisms of secondary contamination to vegetative form. Unlike the spore form, the vegetative part of microflora is better sterilized at pasteurization temperature 68-72° C. During keeping milk at 12-37° C. the DPPA increases the ability of a wide variety of spores to germinate and makes this process faster. Therefore within 30 minutes after germinating spores the milk in hermetic package is delivered to tunnel apparatus of secondary pasteurization 9 for secondary pasteurization where milk is heated from 12-37° C. to 68-72° C. in order to eliminate the vegetative form of germinated spores. For proper effect the heating must be carried out through all the volume of the product at the rate which is not less than 10° C. a second with the help of UHF-radiators, installed along the transporter belt with hermetically packed milk on it. Instant milk temperature increase spasmodic throughout all its volume helps to sterilize microflora in milk throughout all its volume more effectively due to peculiarities of microorganisms decontamination kinetics. At this stage during the process of secondary pasteurization all vegetative microflora of raw milk and package is being eliminated, and impenetrability of package prevents microflora from getting to milk from the outside. At this stage the DPPA contributes to casein solution and prevents the breach of calcium-phosphoric balance in the process of thermal pasteurization of milk which improves organoleptic properties of final products. Secondary pasteurized milk is delivered to hydrodynamic cooling tunnel 10 for cooling down to 4-6° C. at producing pasteurized milk and to 17-25° C. at producing sour milk products. Hermetically packed pasteurized drinking milk is further delivered to drying apparatus 11 where excessive moisture is removed from the surface of packed milk, after that drinking pasteurized milk is delivered to apparatus of packing and labeling 12 with its further storage in cooling chamber. At producing sour milk products secondary pasteurized milk or milk with filling is delivered to apparatus of direct applying ferment 13 after drying apparatus. In apparatus 13 the packing film is preliminarily removed and dry or liquid ferment is applied by syringing or other method, e.g. in tableted form, in the presence of ultra-violet radiation for sterilizing the medium in the area of applying ferment. Tableted ferment may include gas-barbotage mixture when mixing milk with ferment is not required. At the stage of sour-milk fermentation the polyphosphoric acid derivative taken from the above mentioned range contributes to protein solution and restoring calcium-phosphoric balance and stimulates acidogenesis of sour milk microorganisms which eventually improves organoleptic indices of sour milk produce. After applying ferment soured bottled milk is delivered to apparatus of packing and labeling 12 where in the area of ultra-violet radiation the bottles are finally sealed with lids and labeled. The labeled bottles with soured and hermetically sealed milk is further delivered to block-packing apparatus 14 where the bottles are set into blocks and covered in polymeric film. These blocks are delivered onto the transporter of shaking belt conveyor 15 where they are shaken if necessary, which provides even distribution of ferment throughout all the volume of the bottled milk. Then the blocks are delivered to thermostatic chamber 16 where they are kept at 17-25° C. for 8-12 hours. Soured kefir with dense clot and acidity which is 75-80° T or other sour milk product is delivered to cooling chamber 17 for cooling down to 8° C. and ripening at this temperature.

### Certain Variants of Realization the Method of Treating Milk

Each example describes the process of producing drinking milk and a sour milk product on its basis. The Table shows the parameters and the results of these processes for drinking milk and after an oblique stroke for a sour milk product.

### EXAMPLE 1

Pre-purified from mechanical admixtures milk with initial acidity being 17° T was preliminarily heated in thermizator 3 to 55° C. at producing pasteurized milk and to 70° C. at producing kefir. Before the first dispersion (homogenization) and pasteurization the milk was supplied with a well-soluble (abbreviated as ws—in the table) derivative of polyphosphoric acid (abbreviated dppa in the table) which is the salt of polyphosphoric acid with the formula HO—[PO₃X]ₙ—PO₃X₂ with X being alkaline metal Na, n=1-9 at 0.6 g per 1 litre of milk. Dispersion was carried out in 5-stage rotary pulsation apparatus (S-emulsifier) 4.2. in recirculation mode at pasteurization temperature 68° C. for producing drinking pasteurized milk and at 80° C. for producing kefir until the degree of homogeneity of the butter-fat globules was 0.45 mcm. After the first dispersion and pasteurization the milk was delivered to setting reservoir 6 where it was kept at 68° C. for 15 minutes. At producing drinking milk after the first dispersion and pasteurization and the mentioned above keeping at 68° C. without pre-cooling in heat-exchanger 19 the milk was further delivered to bottling 7 with hermetic packing where it was further kept for about 10 minutes (approximate bottling time). The total time for keeping milk at this temperature in setting reservoir 6 and in bottling device 7 was 25 minutes. At producing kefir before keeping in setting reservoir 6 the milk was cooled from 80° C. to 68° C. in cooling heat exchanger 19, kept there for 5 minutes, delivered to bottling device 7 for bottling and germetic sealing at keeping temperature 68° C. The total time for keeping milk for producing kefir at this temperature in setting reservoir 6 and bottling device 7 was 15 minutes. The milk in hermetic package was further delivered to the unit apparatus of hydrodynamic tunnel 8 where it was cooled down to 24° C. in convective cooling section 8.1. and kept in package in 8.2. at this temperature for not less than 30 minutes, after that the milk was pasteurized once again with the use of UHF radiators in tunnel apparatus of secondary pasteurization 9 at 68° C. At producing drinking pasteurized milk after secondary pasteurization the milk was cooled from 68° C. to 4-6° C. in hydrodynamic cooling tunnel 10, then delivered to drying apparatus 11, then to apparatus of packing and labeling 12. This bottled, labeled and sealed milk was further delivered to cooling chamber 17 where it was stored at 4-6° C. At producing sour milk products on the basis of milk processed by the described above method after the secondary pasteurization the milk was cooled from 68° C. to 17-25° C. in hydrodynamic cooling tunnel 10, then delivered to drying apparatus 11, then to device of direct applying ferment 13 where the milk was fermented by direct applying ferment into each package of milk. After fermentation, secondary hermetic packing and labeling in apparatus 12, forming blocks of bottles in apparatus 14, shaking on shaking belt conveyor 15 the fermented packed milk was delivered to thermostatic chamber 16 for keeping at 17-25° C. and fermentation for 8-12 hours. Soured kefir with dense clot and acidity which was 75-80° T was delivered to cooling chamber for cooling down and ripening at 8° C.

### EXAMPLE 2

Milk was processed in accordance with example 1 with the following alterations: the temperature of pre-heating milk was 65° C. at producing drinking milk, 80° C. at producing kefir, the DPPA was presented by a well-dissoluble (wd) derivative of polyphosphoric acid with the formula HO—[PO₃X], —PO₃X₂, with X being alkaline metal K, n=10-25, at 0.5 g per 1 litre of milk, dispersion and pasteurization of milk were carried out at 72° C. for drinking milk, at 85° C. for kefir until the degree of homogeneity of the butter-fat globules was 0.44 mcm, after that the milk was kept at 72° C. for totally 25 minutes at producing drinking milk, for 20 minutes at producing kefir with pre-cooling milk for it in cooling heat exchanger 19 from 85° C. to 72° C. After hot bottling the milk was further cooled down to 37° C. and kept at this temperature for 30 minutes and then delivered for secondary pasteurization up to 72° C.

### EXAMPLE 3

Milk was processed in accordance with example 1 with the following alterations: the temperature of pre-heating milk was 60° C. at producing drinking milk, 75° C. at producing kefir, the DPPA was presented by a well-dissoluble (wd) derivative of polyphosphoric acid with the formula HO—[PO₃X]ₙ—PO₃X₂, with X being ammonium ion, n=1-2, at 0.05 g per 1 litre of milk, dispersion and pasteurization of milk were carried out at 72° C. for drinking milk, at 85° C. for kefir until the degree of homogeneity of the butter-fat globules was 0.43 mcm. After that the milk was kept at 72° C. for totally 35 minutes at producing drinking milk, for 15 minutes at producing kefir with pre-cooling milk for kefir in cooling heat exchanger 19 to 72° C., after hot bottling the milk was further cooled down to 25° C. and kept at this temperature for 40 minutes and then delivered for secondary pasteurization up to 71° C.

### EXAMPLE 4

Milk was processed in accordance with example 1 with the following alterations: the temperature of pre-heating milk was 62° C. at producing drinking milk, 77° C. at producing kefir, the DPPA was presented by a well-dissoluble (wd) derivative of polyphosphoric acid with the formula HO—[PO₃X]ₙ—PO₃X₂, with X being hydrogen ion, n=1-2, at 0.4 g per 1 litre of milk, dispersion and pasteurization of milk were carried out at 69° C. for drinking milk, at 82° C. for kefir until the degree of homogeneity of the butter-fat globules was 0.40 mcm. After that the milk was kept at 69° C. for totally 30 minutes at producing drinking milk, for 20 minutes at producing kefir with pre-cooling milk for kefir in cooling heat exchanger 19 to 69° C. After hot bottling the milk was further cooled down to 30° C. and kept at this temperature for 35 minutes and then delivered for secondary pasteurization up to 72° C.

### EXAMPLE 5

Milk was processed in accordance with example 1 with the following alterations: the temperature of pre-heating milk was 64° C. at producing drinking milk, 78° C. at producing kefir, the DPPA was presented by a well-dissoluble (wd) derivative of polyphosphoric acid with the formula HO—[PO₃X]ₙ—PO₃X₂, with X being potassium, n≧30, at 0.8 g per 1 litre of milk, dispersion and pasteurization of milk were carried out at 72° C. for drinking milk, at 85° C. for kefir until the degree of homogeneity of the butter-fat globules was 0.43 mcm. After that the milk was kept at 72° C. for totally 25 minutes at producing drinking milk, for 15 minutes at producing kefir with pre-cooling milk for kefir in cooling heat exchanger 19 to 72° C. After hot bottling the milk was further cooled down to 12° C. and kept at this temperature for 40 minutes and then delivered for secondary pasteurization up to 69° C.

### EXAMPLE 6

Milk was processed in accordance with example 1 with the following alterations: the temperature of pre-heating milk was 65° C. at producing drinking milk, 80° C. at producing kefir, the DPPA was presented by a badly-dissoluble (bd) derivative of polyphosphoric acid with the formula HO—[PO₃X]ₙ—PO₃X₂, with X being calcium, n=20, at 0.7 g per 1 litre of milk, dispersion and pasteurization of milk were carried out at 72° C. for drinking milk, at 85° C. for kefir until the degree of homogeneity of the butter-fat globules was 0.40 mcm. After that the milk was kept at 72° C. for totally 30 minutes at producing drinking milk, for 20 minutes at producing kefir with pre-cooling milk for kefir in cooling heat exchanger 19 to 72° C. After hot bottling the milk was further cooled down to 35° C. and kept at this temperature for 30 minutes and then delivered for secondary pasteurization up to 72° C.

### EXAMPLE 7

Milk was processed in accordance with example 1 with the following alterations: the temperature of pre-heating milk was 63° C. at producing drinking milk, 76° C. at producing kefir, the DPPA was presented by a well-dissoluble (wd) derivative of polyphosphoric acid with the formula HO—[PO₃X]ₙ—PO₃X₂, with X being magnesium, n=1-2, at 0.4 g per 1 litre of milk, dispersion and pasteurization of milk were carried out at 70° C. for drinking milk, at 81° C. for kefir until the degree of homogeneity of the butter-fat globules was 0.42 mcm. After that the milk was kept at 70° C. for totally 35 minutes at producing drinking milk, for 20 minutes at producing kefir with pre-cooling milk for kefir in cooling heat exchanger 19 to 70° C. After hot bottling the milk was further cooled down to 20° C. and kept at this temperature for 35 minutes and then delivered for secondary pasteurization up to 70° C.

### EXAMPLE 8

Milk was processed in accordance with example 1 with the following alterations: the temperature of pre-heating milk was 64° C. at producing drinking milk, 78° C. at producing kefir, the DPPA was presented by a badly-dissoluble (bd) derivative of polyphosphoric acid with the formula HO—[PO₃X], —PO₃X₂, with X being magnesium, n=5-9, at 0.4 g per 1 litre of milk, dispersion and pasteurization of milk were carried out at 69° C. for drinking milk, at 82° C. for kefir until the degree of homogeneity of the butter-fat globules was 0.44 mcm. After that the milk was kept at 69° C. for totally 25 minutes at producing drinking milk, for 15 minutes at producing kefir with pre-cooling milk for kefir in cooling heat exchanger 19 to 69° C. After hot bottling the milk was further cooled down to 32° C. and kept at this temperature for 35 minutes and then delivered for secondary pasteurization up to 70° C.

### EXAMPLE 9

Milk was processed in accordance with example 1 with the following alterations: the temperature of pre-heating milk was 68° C. at producing drinking milk, 83° C. at producing kefir, the DPPA was presented by a non-dissoluble (bd) derivative of polyphosphoric acid with the formula HO—[PO₃X]ₙ—PO₃X₂, with X being calcium, n=10-25, at 0.7 g per 1 litre of milk, dispersion and pasteurization of milk were carried out at 76° C. for drinking milk, at 90° C. for kefir until the degree of homogeneity of the butter-fat globules was 0.40 mcm. After that the milk was kept at 76° C. for totally 40 minutes at producing drinking milk, for 30 minutes at producing kefir with pre-cooling milk for kefir in cooling heat exchanger 19 to 76° C. After hot bottling the milk was further cooled down to 37° C. and kept at this temperature for 45 minutes and then delivered for secondary pasteurization up to 76° C.

### EXAMPLE 10

Milk was processed in accordance with example 1 with the following alterations: the temperature of pre-heating milk was 60° C. at producing drinking milk, 83° C. at producing kefir, the DPPA was presented by a well-dissoluble (wd) derivative of polyphosphoric acid with the formula HO—[PO₃X]ₙ—PO₃X₂, with X being potassium, n=1-9, at 0.5 g per 1 litre of milk, dispersion and pasteurization of milk were carried out on disperser RPA-15 at 69° C. for drinking milk, at 82° C. for kefir until the degree of homogeneity of the butter-fat globules was 0.43 mcm. After that the milk was kept at 69° C. for totally 30 minutes at producing drinking milk, for 20 minutes at producing kefir with pre-cooling milk for kefir in cooling heat exchanger 19 to 69° C. After hot bottling the milk was further cooled down to 36° C. and kept at this temperature for 30 minutes and then delivered for secondary pasteurization up to 72° C.

### EXAMPLE 11

Milk was processed in accordance with example 1 with the following alterations: the temperature of pre-heating milk was 62° C. at producing drinking milk, 77° C. at producing kefir, the DPPA was presented by a non-dissoluble (nd) derivative of polyphosphoric acid with the formula HO—[PO₃X]ₙ—PO₃X₂, with X being calcium, n≧30, at 0.7 g per 1 litre of milk, dispersion and pasteurization of milk were carried out on disperser RPA-15 at 72° C. for drinking milk, at 85° C. for kefir until the degree of homogeneity of the butter-fat globules was 0.41 mcm. After that the milk was kept at 72° C. for totally 30 minutes at producing drinking milk, for 15 minutes at producing kefir with pre-cooling milk for kefir in cooling heat exchanger 19 to 72° C. After hot bottling the milk was further cooled down to 28° C. and kept at this temperature for 30 minutes and then delivered for secondary pasteurization up to 71° C.

### EXAMPLE 12

Milk was processed in accordance with example 1 with the following alterations: the temperature of pre-heating milk was 65° C. at producing drinking milk, 79° C. at producing kefir, the DPPA was presented by a well-dissoluble (wd) derivative of polyphosphoric acid with the formula HO—[PO₃X]ₙ—PO₃X₂, with X being ammonium ion, n≧30, at 0.5 g per 1 litre of milk, dispersion and pasteurization of milk were carried out on disperser at 71° C. for drinking milk, at 82° C. for kefir until the degree of homogeneity of the butter-fat globules was 0.42 mcm. After that the milk was kept at 71° C. for totally 35 minutes at producing drinking milk, for 20 minutes at producing kefir with pre-cooling milk for kefir in cooling heat exchanger 19 to 71° C. After hot bottling the milk was further cooled down to 25° C. and kept at this temperature for 35 minutes and then delivered for secondary pasteurization up to 70° C.

### EXAMPLE 13

Milk was processed in accordance with example 1 with the following alterations: the temperature of pre-heating milk was 66° C. at producing drinking milk, 79° C. at producing kefir, the DPPA was presented by a non-dissoluble (nd) derivative of polyphosphoric acid with the formula HO—[PO₃X]ₙ—PO₃X₂, with X being magnesium, n=10-25, at 0.6 g per 1 litre of milk, dispersion and pasteurization of milk were carried out on disperser at 72° C. for drinking milk, at 84° C. for kefir until the degree of homogeneity of the butter-fat globules was 0.44 mcm. After that the milk was kept at 72° C. for totally 30 minutes at producing drinking milk, for 15 minutes at producing kefir with pre-cooling milk for kefir in cooling heat exchanger 19 to 72° C. After hot bottling the milk was further cooled down to 34° C. and kept at this temperature for 35 minutes and then delivered for secondary pasteurization up to 69° C.

### EXAMPLE 14

Milk was processed in accordance with example 1 with the following alterations: the temperature of pre-heating milk was 60° C. at producing drinking milk, 75° C. at producing acidophilin, the DPPA was presented by a well-dissoluble (wd) derivative of polyphosphoric acid with the formula HO—[PO₃X]ₙ—PO₃X₂, with X being sodium, n=15-20, at 0.4 g per 1 litre of milk, dispersion and pasteurization of milk were carried out at 72° C. for drinking milk, at 85° C. for acidophilin until the degree of homogeneity of the butter-fat globules was 0.40 mcm. After that the milk was kept at 72° C. for totally 30 minutes at producing drinking milk, for 15 minutes at producing acidophilin with pre-cooling milk for acidophilin in cooling heat exchanger 19 to 72° C. After hot bottling the milk was further cooled down to 12° C. and kept at this temperature for 45 minutes and then delivered for secondary pasteurization up to 72° C.

### EXAMPLE 15

The process of producing kefir was carried out by thermostatic method with progressive method of processing milk for kefir in accordance with patent of RU No. 2222952 when milk was pre-heated up to 45° C. with the use of infra-red radiator, then simultaneously dispersed and pasteurized to 72° C. twice until the degree of homogeneity was 0.5-1.1 mcm with the use of a 5-stage emulsifier.

### EXAMPLE 16

The process of producing kefir was carried out by thermostatic method with traditional method of processing milk on plunger homogenizer with a single pasteurization to 80-85° C.

### The Best Variants of Performing the Invention

As seen from the Table, at observing all the conditions of treating milk and producing sour fermented milk products given in the invention formula in comparison with the analogues and the prototype there is an increase in thermostability of milk, expiry terms of drinking milk and sour milk products, improving organoleptic taste properties of drinking milk and sour milk products. This is shown by examples 1, 2, 4, 7, 10, 12, 14. When exceeding some of the conditions not all the characteristics improve. Thus, example 6 that illustrates treating milk and producing sour milk products with the use of badly-dissoluble derivative of polyphosphoric acid with calcium provides the improvement of thermostability, organoleptic properties of kefir, increasing of expiry terms, but does not improve the taste of milk (neither does it worsen it). In example 3 derivative of polyphosphoric acid is taken in quantity which is approximately one order of magnitude less than it is suggested, that is why thermostability is not improved, the taste is not changed, though expiry terms of milk and kefir have increased in comparison with the analogue, prototype. In example 5 overdose of derivative of polyphosphoric acid at 0.1 g per litre (totally 0.8 g per litre) improves thermostability of milk, increases expiry terms of milk and sour milk products, but decreases organoleptic properties. Non-dissoluble derivatives of polyphosphoric acid (examples 9, 11, 13) increase expiry terms, but worsen the taste of produce. At setting pasteurization temperature more than suggested (example 9) there appears the taste of over-pasteurization milk. Thus, the task set is solved only within the indications of the invention, which are reflected in independent items of the claimes. For all this, depending on the variant of performing the invention one can see better or worse results within the problem solved in comparison with the best variants. Thus, the most effective are supposed to be those variants which involve well-dissoluble in milk derivatives of polyphosphoric acid (see wd in column 6 of the Table) taken within the applied quantitative diapason, with low values of “n” being 1-25, when there is a significant increase in expiry terms (22-30 days) and thermostability (category 1). Such are examples 2, 4, 7, 10, 14 and some others. In terms of improving organoleptic properties of milk and sour milk products the best are supposed those variants which involve the least quantity of derivative of polyphosphoric acid within the applied quantitative diapason. At any rate, in comparison with the prototype there is a significant increase in expiry terms of milk and value of thermostability, improvement of organoleptic properties of milk and sour milk products on its basis.

### REFERENCES

1. Bredichin A. S., Kosmodemyansky Y. V., Yurin V. N. Technology and technics of processing milk. Moscow, Kolos, 2001, 399 pages, p. 272, 273, 275—prototype for method and production line of producing sour milk products;
2. Patent of Russia No 2166885, Method of producing pasteurized milk (variants), IPC7 A23C9/00, published May 20, 2001.;

3. Patent of Russia No. 2222952, Method of producing drinking milk and the processing line for it, IPC7 A23C9/00,3/00, A01J11/00, published Feb. 10, 2004. bulletin No. 4—prototype for method and device of treating milk.

TABLE
Conditions of producing sour milk products and treating milk and their results

| | | | | | | | | | | Temperature |
|---|---|---|---|---|---|---|---|---|---|---|
| | | | | | | | | | Total time of | of keeping |
| | Milk heating | | | | | | | Temperature | keeping after | between |
| | in the | | | | | Butter- | | of the first | the first | the first |
| | thermizator | | | | | fat | | pasteurization | pasteurization | and second |
| | for milk/for | DPPA | | | | globules | | for milk/for | for milk/for | pasteur- |
| | sour milk | dosage, | Type | Value | Solubility | diameter, | Disperser | sour milk | sour milk | ization, |
| Example | products, ° C. | g/l | of X | of n | in milk | mcm | type | products, ° C. | products, ° C. | ° C. |
| 1 | 2 | 3 | 4 | 5 | 6 | 7 | 8 | 9 | 10 | 11 |
| 1 | 55/70 | 0.6/0.6 | Na | 1-9 | wd | 0.45 | S-emulsifier | 68/80 | 25/15 | 24/24 |
| 2 | 65/80 | 0.5/0.5 | K | 10-25 | wd | 0.44 | S-emulsifier | 72/85 | 25/20 | 37/37 |
| 3 | 60/75 | 0.05/0.05 | NH₄⁺ | 1-2 | wd | 0.43 | S-emulsifier | 72/85 | 35/15 | 25/25 |
| 4 | 62/77 | 0.4/04 | H⁺ | 1-2 | wd | 0.40 | S-emulsifier | 69/82 | 30/20 | 30/30 |
| 5 | 64/78 | 0.8/0.8 | K | ≧30 | wd | 0.43 | S-emulsifier | 72/85 | 25/15 | 12/12 |
| 6 | 65/80 | 0.7/0.7 | Ca | 2 | bd | 0.40 | S-emulsifier | 72/85 | 30/20 | 35/35 |
| 7 | 63/76 | 0.4/0.4 | Mg | 1-2 | wd | 0.42 | S-emulsifier | 70/81 | 35/20 | 20/20 |
| 8 | 64/78 | 0.4/0.4 | Mg | 5-9 | bd | 0.44 | S-emulsifier | 69/82 | 25/15 | 32/32 |
| 9 | 68/83 | 0.7/0.7 | Ca | 10-25 | nd | 0.40 | S-emulsifier | 76/90 | 40/30 | 37/37 |
| 10 | 60/75 | 0.5/0.5 | K | 1-9 | wd | 0.43 | Disperser | 69/82 | 30\20 | 36/36 |
| | | | | | | | RPA-15 | | | |
| 11 | 62/77 | 0.7/0.7 | Ca | ≧30 | nd | 0.41 | Disperser | 72/85 | 30/15 | 28/28 |
| | | | | | | | RPA-15 | | | |
| 12 | 65/79 | 0.5/0.5 | NH₄⁺ | ≧30 | wd | 0.42 | Homogenizer | 71/82 | 35/20 | 25/25 |
| 13 | 66/79 | 0.6/0.6 | Mg | 10-25 | nd | 0.44 | Homogenizer | 72/84 | 30/15 | 34/34 |
| 14 | 60/75 | 0.4/0.4 | Na | 15-20 | wd | 0.40 | S-emulsifier | 72/85 | 30/15 | 12/12 |
| 15 | 45 | — | — | — | — | 0.5-1.1 | S-emulsifier | 72 | — | — |
| proto- | With IR | | | | | | | | | |
| type | radiator | | | | | | | | | |
| 16 | — | — | — | — | — | — | Plunger | 80-85 | — | — |
| | | | | | | | homogenizer | | | |

| | Duration of | Temperature | | | | | |
|---|---|---|---|---|---|---|---|
| | keeping between | of the | | Expiry period | | | |
| | the first and | second | | of milk/of | | | |
| | second | pasteurization | | sour milk | | | |
| | pasteurization, | for milk/for | Thermo- | products in | Acidity | | |
| | for milk/for | sour milk | stability | non-aseptic | of raw | | Organoleptic properties |
| | sour milk | products, | of mil, | package, | milk, | Organoleptic properties | of kefir (the |
| Example | products, min | ° C. | category | days | ° T | of drinking milk | thermostatic method) |
| 1 | 12 | 13 | 14 | 15 | 16 | 17 | 18 |
| 1 | 30/30 | 68/68 | I | 20/6 | 17 | No smack of pasteurization, | Strongly marked taste |
| | | | | | | marked taste of native milk | and smell, dense clot |
| | | | | | | | (kefir) |
| 2 | 30/30 | 72/72 | I | 29/9 | 17 | No smack of pasteurization, | Strongly marked taste |
| | | | | | | marked taste of native milk | and smell, dense clot |
| 3 | 40/40 | 71/71 | III | 14/4 | 17 | No smack of pasteurization, | Distinctive taste and |
| | | | | | | distinctive milk taste | smell, medium dense |
| | | | | | | | clot |
| 4 | 35/35 | 72/72 | I | 25/5 | 16 | No smack of pasteurization, | Strongly marked taste |
| | | | | | | marked taste of native milk | and smell, dense clot |
| 5 | 40/40 | 69/69 | I | 33/10 | 18 | No smack of pasteurization. | Typical taste, untypical |
| | | | | | | Presence of soap taste | smell. Dense clot |
| 6 | 30/30 | 72/72 | II | 24/5 | 17 | No smack of pasteurization, | Distinctive taste and |
| | | | | | | (typical) milk taste | smell, medium dense |
| | | | | | | | clot |
| 7 | 35/35 | 70/70 | I | 22/5 | 17 | No smack of pasteurization, | Strongly marked taste |
| | | | | | | marked taste of native milk | and smell, dense clot |
| 8 | 35/35 | 70/70 | III | 23/5 | 17 | No smack of pasteurization, | Distinctive taste and |
| | | | | | | feeble milk taste | smell, medium dense |
| | | | | | | | clot |
| 9 | 45/45 | 76/76 | III | 35/10 | 18 | Smack of pasteurization. | Distinctive taste and |
| | | | | | | | smell, medium dense |
| | | | | | | | clot |
| 10 | 30/30 | 72/72 | I | 27/8 | 17 | No smack of pasteurization, | Strongly marked taste |
| | | | | | | marked taste of native milk | and smell, dense clot |
| 11 | 30/30 | 71/71 | III | 18/3 | 16 | No smack of pasteurization, | Distinctive taste and |
| | | | | | | feeble milk taste | smell, medium dense |
| | | | | | | | clot |
| 12 | 35/35 | 70/70 | I | 22/4 | 18 | No smack of pasteurization, | Strongly marked taste |
| | | | | | | marked taste of native milk | and smell, dense clot |
| 13 | 35/35 | 69/69 | III | 19/4 | 18 | No smack of pasteurization, | Distinctive taste and |
| | | | | | | feeble milk taste | smell, medium dense |
| | | | | | | | clot |
| 14 | 45/45 | 72/72 | I | 30/10 | 16 | No smack of pasteurization, | Strongly marked taste |
| | | | | | | marked taste of native milk | and smell, dense clot |
| | | | | | | | (acidophilin) |
| 15 | — | 72 | III | 12/3 | 18 | No smack of pasteurization, | Distinctive taste and |
| proto- | | | | | | distinctive milk taste | smell, thin to medium |
| type | | | | | | | dense clot |
| 16 | — | — | III | 5/2 | 17 | Smack of pasteurization and | Feeble taste and smell, |
| | | | | | | overpasteurization | thin clot |

Abbreviations:
SMP—sour milk products
dppa—derivative of polyphosphoric acid
wd—well-dissoluble in milk (in milk plasma)
bd—badly-dissoluble in milk (in milk plasma)
nd—non-dissoluble in milk (in milk plasma)

1. The method for producing sour milk products including treating milk with pasteurization and homogenizing, fermenting milk by the way of direct applying ferment, bottling and packing, fermenting with thermostatic keeping, cooling, ripening, distinguishing by the fact that the process of treating milk and the following operations of producing sour milk products are carried out in the presence of a milk soluble polyphosphoric acid derivative of general formula
HO—[PO₃X]ₙ—PO₃X₂,
wherein X represents ions of sodium, or potassium, or calcium, or magnesium, or hydrogen or ammonium, 30≧n≧1 at a quantitative value 0.4-0.7 g per 1 litre, treating milk is carried out with double pasteurization, bottling and packing are carried out with hermetic sealing at 68-72° C. before the second pasteurization, ferment is applied into hermetically sealed milk at its depressurization, with ultra-violet treating of the area of applying ferment and final hermetic sealing of package afterwards.

2. The method of producing sour milk products in item 1, distinguishing by stirring the sealed product by the method of shaking after applying ferment.

3. The method of producing sour milk products in item 1, distinguishing by additional operation of applying pasteurized pieces of vegetables, or fruit or berries or other fillings into milk after its first pasteurization at 68-72° C. for milk and sour milk products on its basis, at the temperature of stewing for stewed milk and products on its basis.

4. The method for treating milk including combined process of dispersion (homogenizing) and pasteurization with double pasteurization, bottling with hermetic sealing, distinguishing by the fact that treating milk is carried out in the presence of soluble in milk derivative of polyphosphoric acid that has the general formula
HO—[PO₃X]ₙ—PO₃X₂
wherein X represents ions of sodium, or potassium, or calcium, or magnesium, or hydrogen or ammonium, 30≧n≧1, with its quantitative value being 0.4-0.7 g per 1 litre; after the first pasteurization the milk is kept at 68-72° C. for not less than 15 minutes for drinking milk, not less than 5 minutes for sour milk products; bottling with hermetic sealing is carried out after this keeping at the temperature of this keeping, then hermetically sealed milk is cooled down to 12-37° C. and kept at this temperature for not less than 30 minutes; the second pasteurization is carried out after the above mentioned keeping with heating milk to 68-72° C. at the rate which is not less than 10° C. per second.

5. The method for treating milk in item 4, distinguishing by carrying out dispersion (homogenization) until the size of the butter-fat globules is not more than 0.5 mcm.

6. The sour milk production line containing consequently connected by a transporting system in the order of technological operations device for treating milk with a homogenizer, a pasteurization plant, a device for direct applying ferment, a bottling device with hermetic sealing device, a thermostatic chamber, a cooling chamber, distinguishing by the position of the bottling device with hermetic sealing device before the device for direct applying ferment; the device for direct applying ferment is complemented by a depressurization device, a final hermetic sealing device which is located after the device for direct applying ferment, ultra-violet radiators installed along the area of applying ferment.

7. The sour milk production line in item 6 distinguishing by equipping with the device for stirring milk with ferment which is designed as a shaking belt conveyor installed between the device for applying ferment and the thermostatic chamber.

8. The sour milk production line in item 6 distinguishing by the design of the transporting device after the bottling device as a belt conveyor.

9. The device for treating milk containing installed in the order of technological operations and consequently connected by a transporting system recirculation reservoir, disperser with a pasteurization plant, a bottling device with a hermetic sealing device, cooling chamber; the output of the disperser is connected to the input of the recirculation reservoir whose output is connected to the input of the disperser providing closed circuit of frequentative circulation of milk through the disperser, distinguishing by equipping with the additional reservoir for water solution or suspension of the derivative of polyphosphoric acid with general formula
HO—[PO₃X]ₙ—PO₃X₂,
wherein X represents ions of sodium, or potassium, or calcium, or magnesium, or hydrogen or ammonium, 30≧n≧1, with its value being 0.4-0.7 g per 1 litre; this reservoir is connected with the input of the disperser; the device is equipped with a reservoir for keeping milk at 68-72° C., whose input is connected to the output of the disperser, and the output is connected to the bottling device and the cooler which is designed for cooling milk down to 12-37° C. and installed after the bottling device; the device for processing milk is equipped with a setting reservoir that provides the temperature of milk 12-37° C. and a tunnel apparatus of secondary pasteurization with a transporter belt which is equipped with UHF radiators installed along the belt, with milk heating rate as 11° C. per sec up to 68-72° C.

10. The device for treating milk in item 9 distinguishing by the design of the reservoir as an apparatus of stirring or displacement with a jacket connected to a current of heat carrier.

11. The device for treating milk in item 9 distinguishing by the design of the reservoir as a hydrodynamic cooling tunnel of a passage type.
